(19) United States
(12) Patent Application Publication
(10) Pub. No.: US 2014/0222618 A1
(43) Pub. Date: Aug. 7, 2014

(54) SYSTEM AND METHOD FOR BIDDING

(71) Applicant: CAA SOUTH CENTRAL ONTARIO, Thornhill (CA)

(72) Inventors: Chris Stamp, Stouffville (CA); Kirk Serjeanston, Markham (CA); Cindy Hillaby, Richmond Hill (CA)

(73) Assignee: CAA SOUTH CENTRAL ONTARIO, Thornhill (CA)

(21) Appl. No.: 13/759,680

(22) Filed: Feb. 5, 2013

(51) Int. Cl. G06Q 30/06

(52) U.S. Cl. CPC G06Q 30/0611
USPC 705/26.35; 705/26.4

(57) ABSTRACT

The described embodiments relate to systems, methods and computer readable media for bidding on service requests, that involves receiving a service request, wherein the service request comprises a user identifier, a location and a destination; generating a bid request corresponding to the service request; receiving a plurality of bids, wherein each bid comprises a service provider identifier for a corresponding service provider, a cost and a service time; transmitting the plurality of bids; and receiving a selected bid of the plurality of bids.

### FIELD

The embodiments described herein relate to the field of coordinating service requests and service providers, and in particular, to the field of bidding on service requests.

### INTRODUCTION

Typically, a person requiring service, such as a person with a vehicle problem, places a telephone call to a service provider, such as towing company, in order to request and schedule service, such as tow for their vehicle. If the person requiring service would like to compare rates from different service providers they may need to place multiple telephone calls to multiple service providers, which can be inefficient and inconvenient. There exists a need for improved methods of coordinating a service request and a service provider, such as a towing company.

### SUMMARY

In a first aspect, embodiments described herein may provide a computer implemented method for bidding on service requests wherein the computer involves a processor and a memory coupled to the processor and configured to store instructions executable by the processor to perform the method comprising: receiving a service request from a user device, wherein the service request indicates a user identifier, an item to be service, a location and a destination; generating a bid request corresponding to the service request; receiving a plurality of bids from a corresponding plurality of service provider devices, wherein each bid indicates a service provider identifier for a corresponding service provider, a cost for servicing the item and a service time; transmitting the plurality of bids to the user device; and receiving a selected bid of the plurality of bids from the user device.

In accordance with some embodiments, the service request further indicates a requested service time.

In accordance with some embodiments, the service request is received from a user computing application executing on the user device, and the location is automatically determined using a global positioning system of the user device.

In accordance with some embodiments, each of the plurality of bids is received by a bidder computing application executing on the service provider device of the corresponding service provider.

In accordance with some embodiments, the method may further involve sending a notification to the service provider device corresponding to the selected bid, wherein the notification indicates that their bid was selected.

In accordance with some embodiments, the method may further involve sending a notification to each of the remaining services provider devices, wherein the notification indicates that their bid was not selected, and the cost and the service time of the selected bid.

In accordance with some embodiments, the method may further involve providing a price range for a reasonable bid for the location and the destination, wherein the price range is generated based on at least one of historical data for similar service requests and industry standards.

In accordance with some embodiments, the method may further involve generating an additional bid based on the received plurality of bids, and transmitting the additional bid as part of the plurality of bids, wherein the selected bid may be the additional bid.

In accordance with some embodiments, the method may further involve, for each of the plurality of service providers, authenticating the respective service provider using the service provider identifier.

In accordance with some embodiments, the method may further involve receiving server provider authentication data from the user device, authenticating the respective service provider using the service provider authentication data, and transmitting a notification to the user device indicating a result of the authentication.

In accordance with some embodiments, the method may further involve, for each of the plurality of service providers, receiving a defined geographic area for the respective service provider, and transmitting the bid request to the respective service provider only if the location and the destination of the service request is within the defined geographic area for the respective service provider.

In accordance with some embodiments, the method may further involve receiving a second service request; transmitting a second bid request corresponding to the second service request; receiving a plurality of additional bids from a corresponding plurality of additional service providers, wherein each bid comprises a cost and a service time; transmitting the plurality of additional bids; and receiving a selected additional bid of the plurality of additional bids, wherein the selected additional bid corresponds to a selected additional service provider of the plurality of additional service providers. In accordance with some embodiments, the method may further involve, further comprising sending a notification to the selected additional service provider.

In accordance with some embodiments, the service request relates to a service for a vehicle and wherein the bid request comprises a vehicle identifier and one or more known issues with the vehicle.

In accordance with some embodiments, the service request relates to a service for a vehicle, wherein the service request is generated by a computing application executing on a mobile device, and wherein the bid request comprises telematics data for the vehicle, wherein the telematics data is received from a telematics device in communication with the mobile device.

In accordance with some embodiments, the method may further involve authenticating the user based on the user identifier. In accordance with some embodiments, the method may further involve storing the service request, bids and selected bid.

In another aspect embodiments described herein may provide a method for bidding comprising: receiving a service request from a user, wherein the service request comprises a user identifier, a requested service time, a location and a destination; transmitting a bid request corresponding to the service request; receiving a plurality of bids from a corresponding a plurality service providers, wherein each bid comprises a service provider identifier, a cost and a service time; generating a response to the service request based on the received plurality of bids.

In a further aspect, embodiments described herein may provide a system for bidding comprising a processor and a memory coupled to the processor and configured to store instructions executable by the processor to provide: a service request module operable to receive a service request from a user device, wherein the service request indicates a user identifier, an item to be service, a location and a destination; a bid request module operable to generate a bid request corresponding to the service request; a bid module operable to receive a plurality of bids from a corresponding plurality of service provider devices, wherein each bid indicates a service provider identifier for a corresponding service provider, a cost for servicing the item, and a service time; and transmit the plurality of bids to the user device; and receive a selected bid of the plurality of bids from the user device.

In accordance with some embodiments, the system may further involve a notification module operable to send a notification to the service provider corresponding to the selected bid, wherein the notification indicates that their bid was selected, and a notification to each of the remaining services providers, wherein the notification indicates that their bid was not selected and the cost of the selected bid.

In accordance with some embodiments, the system may further involve a comparison module operable to provide a price range for a reasonable bid for the location and destination, wherein the price range is based on at least one of historical data for similar service requests and industry standards.

In accordance with some embodiments, the system may further involve a bid module is further operable to generate an additional bid based on the received plurality of bids and transmit the additional bid as part of the plurality of bids, wherein the selected bid may be the additional bid.

In accordance with some embodiments, the system may further involve an authentication module operable to, for each of the plurality of service providers, authenticate the respective service provider based on the service provider identifier, and authenticate the user based on the user identifier. In accordance with some embodiments, the authentication module may be further configured to receive server provider authentication data from the user device, authenticate the respective service provider using the service provider authentication data, and transmit a notification to the user device indicating a result of the authentication.

In accordance with some embodiments, the bid request module is further operable to, for each of the plurality of service providers, receive a defined geographic area for the respective service provider, and transmit the bid request to the respective service provider only if the location and the destination of the service request is within the defined geographic area for the respective service provider.

In accordance with some embodiments, the service request module is operable to receive a second service request; wherein the bid request module is operable to transmit a second bid request corresponding to the second service request; and wherein the bid module is operable to receive a plurality of additional bids from a corresponding plurality of additional service providers, wherein each bid comprises a cost and a service time, transmit the plurality of additional bids, and receive a selected additional bid of the plurality of additional bids, wherein the selected additional bid corresponds to a selected additional service provider of the plurality of additional service providers.

In accordance with some embodiments, the service request relates to a tow for a vehicle and servicing for the vehicle and where the service request comprises a vehicle identifier and one or more known issues with the vehicle. In accordance with some embodiments, the system may further involve a data storage device operable to store the service request, bids and selected bid.

In accordance with some embodiments, the service request is received by a computing application executing on a mobile device, and where one or more known issues with the vehicle is identified by telematics data for the vehicle, wherein the telematics data is received from a telematics device in communication with the mobile device.

In another aspect, embodiments described herein may provide a computer-readable storage medium storing one or more sequences of instructions which, when executed by one or more processors, causes the one or more processors to perform a method of bidding comprising: receiving a service request from a user device, wherein the service request indicates a user identifier, an item to be service, a location and a destination; generating a bid request corresponding to the service request; receiving a plurality of bids from a corresponding plurality of service provider devices, wherein each bid indicates a service provider identifier for a corresponding service provider, a cost for servicing the item and a service time; transmitting the plurality of bids to the user device; and receiving a selected bid of the plurality of bids from the user device.

In another aspect, embodiments described herein may provide a computer-readable storage medium storing one or more sequences of instructions which, when executed by one or more processors, causes the one or more processors to perform a method of bidding on service requests for a vehicle comprising: determining a location of a user using a global positioning system of a user device, determining one or more issues with a vehicle using telematics data received from a telematics device in communication with the vehicle and the user device, sending a vehicle service request from the user device, wherein the vehicle service request indicates a user identifier, vehicle identifier, the location, a destination, the one or more issues with the vehicle; receiving a plurality of bids corresponding to a plurality of vehicle service provider, wherein each bid indicates a service provider identifier for a corresponding service provider, a cost for servicing the vehicle and a service time; receiving a selected bid of the plurality of bids at the user device; and transmitting the selected bid from the user device.

In another aspect, embodiments described herein may provide a computer-readable storage medium storing one or more sequences of instructions which, when executed by one or more processors, causes the one or more processors to perform a method of bidding comprising: receiving a service request from a user device, wherein the service request indicates a user identifier, an item to be service, a location and a destination; generating a bid request corresponding to the service request; receiving a plurality of bids from a corresponding plurality of service provider devices, wherein each bid indicates a service provider identifier for a corresponding service provider, a cost for servicing the item and a service time; transmitting the plurality of bids to the user device; and receiving a selected bid of the plurality of bids from the user device.

Other aspects and features will become apparent, to those ordinarily skilled in the art, upon review of the following description of some exemplary embodiments.

### DRAWINGS

FIG. 1 is a block diagram of a system for coordinate a service provider with a service request according to one or more embodiments;

FIG. 2a is a block diagram of an application server for processing service requests from users and bids by service providers according to one or more embodiments;

FIG. 2b is a block diagram of a user application for submitting service requests and selecting a bid from a service provider according to one or more embodiments;

FIG. 2c is a block diagram of a bidder application for submitting bids by service providers according to one or more embodiments;

FIG. 3 is a block diagram of an example embodiment of system 10 used in a towing application for receiving a service request according to one or more embodiments;

FIG. 4 is a block diagram of an example embodiment of system 10 used in a towing application for receiving bids from service providers and providing bids to a user according to one or more embodiments;

FIG. 5 is a block diagram of an example embodiment of system 10 used in a towing application for receiving a selected bid request according to one or more embodiments; and

FIG. 6 is a flow chart diagram of a method for submitting service requests and selecting a bid from a service provider according to one or more embodiments.

### DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer useable instructions may also be in various forms, including compiled and non-compiled code.

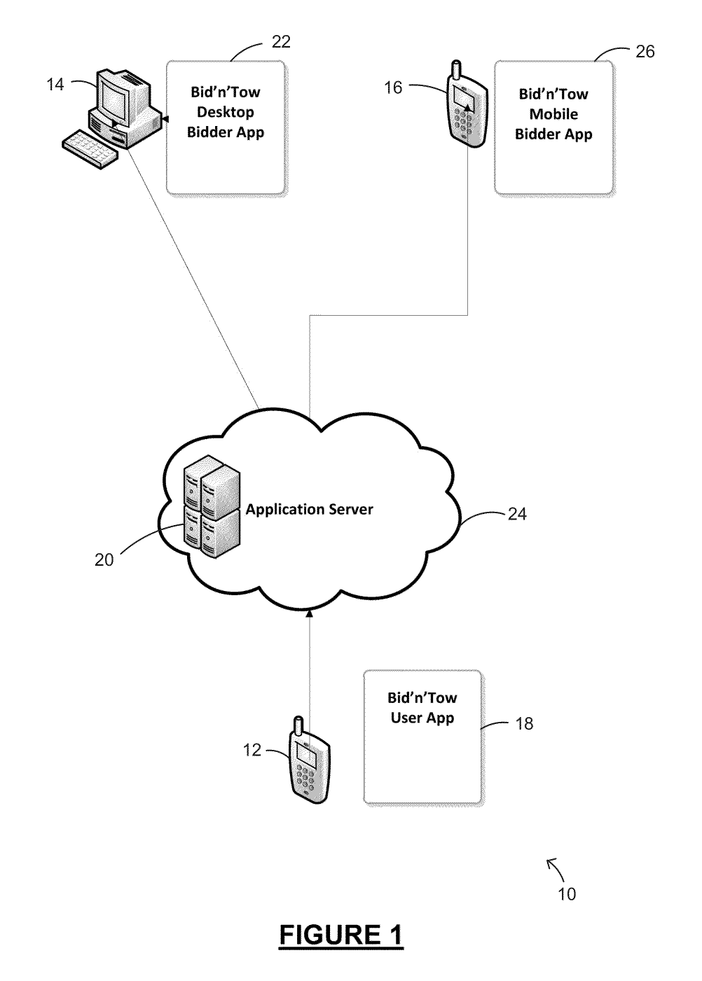

Referring now to FIG. 1 there is shown a block diagram of a system 10 for coordinating a service request with a service provider according to some embodiments. System 10 is operable to provide a bidding process for provision of service based on a location and destination of a user, and provide the user a comparison of bids from service providers in response to a service request. System 10 enables a user to select a bid from a service provider, such as the least expensive bid. This may prevent a typical process where service providers, such as tow truck operators, wait in key locations for breakdowns and may bully people into using their service. This also enables a user to view a comparison of bids (including costs and service times) from a variety of service providers and select their desired bid. This solution allows the user to have control by selecting a service provider from a comparison of service providers, and select a bid based on a preferred service provider, the best price or shortest service time. Further, the solution may enable a user to specify a requested service time and, in response, a service provider can tailor their bid depending on their capacity for that requested service time. For example, a garage providing vehicle repairs may have more capacity on a weekday morning than a weekend afternoon and so may provide a different bid on the service request for vehicle repair depending on the requested service time. The user may or may not be required to be a member of an organization providing services of system 10.

System 10 includes an application server 20 connected to one or more user devices 12 and one or more service provider devices 14/16 via a network 24. Example service provider devices are shown as a desktop computer 14 and a mobile device 16. An example user device 12 is shown as a mobile device. Using the system 10, one or more users may communicate with application server 20 to request provision of service by submitting a service request. Service providers receive the request and, in response, bid on the requested service. The received bids from service providers are provided to the user, who in turns selects a bid from the received bids. The bids may be associated with locations received from global positioning systems associated with the service providers and a mapping interface on the user device 12 may show an icon associated with each bid and its location. Communication between the users and the application server 20 can occur either directly or indirectly using any one or more suitable computing devices. For example, the user may use a user device 12 having one or more client processors such as a desktop or mobile computer that has at least one input device (e.g., a keyboard, a mouse, touch screen, and the like) and at least one output device (e.g., a display screen, speakers, and the like). Communication between the service providers and the application server 20 can occur either directly or indirectly using any one or more suitable computing devices. For example, the service provider may use a service provider device 14/16 having one or more processors such as a desktop or mobile computer that has at least one input device (e.g., a keyboard, a mouse, touch screen, and the like) and at least one output device (e.g., a display screen, speakers, and the like).

Application server 20 may be implemented using a server and data storage devices configured with database(s) or file system(s), or using multiple servers or groups of servers distributed over a wide geographic area and connected via a network 24. Application server 20 may reside on any networked computing device including a processor and memory, such as an electronic reading device, a personal computer, workstation, server, portable computer, mobile device, personal digital assistant, laptop, tablet, smart phone, WAP phone, an interactive television, video display terminals, gaming consoles, and portable electronic devices or a combination of these. Application server 20 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Application server 20 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. Application server 20 may include one or more input devices, such as a keyboard, mouse, camera, touch screen and a microphone, and may also include one or more output devices such as a display screen and a speaker.

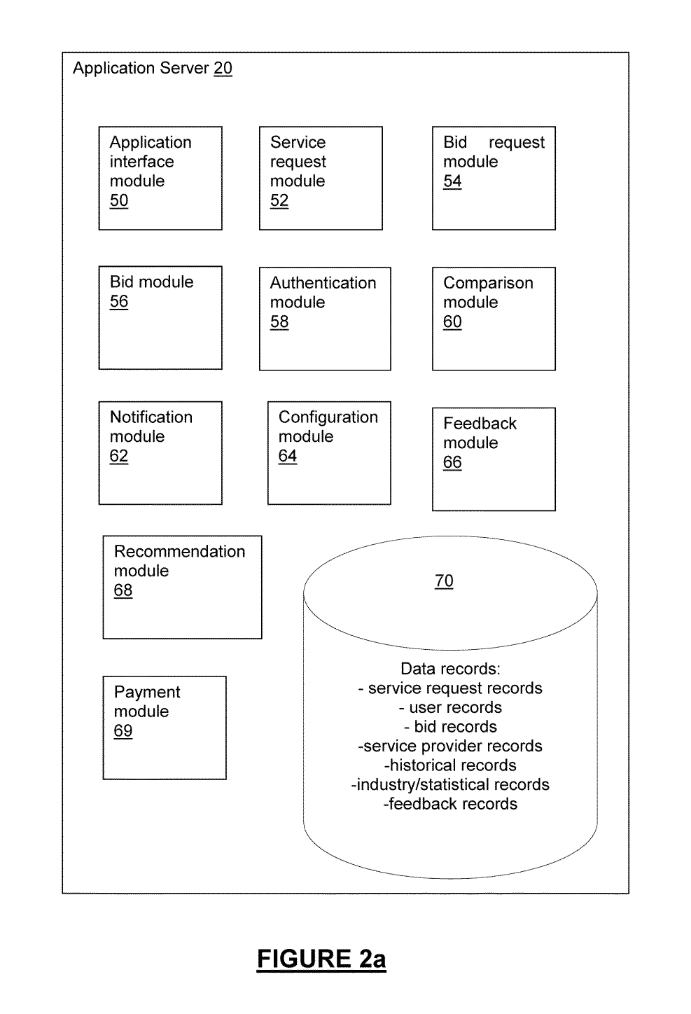

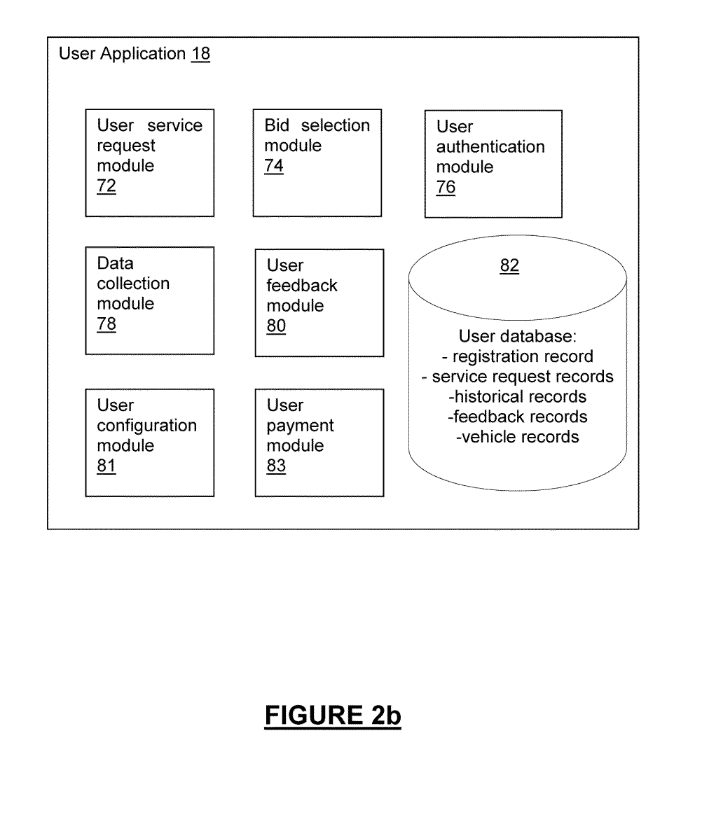

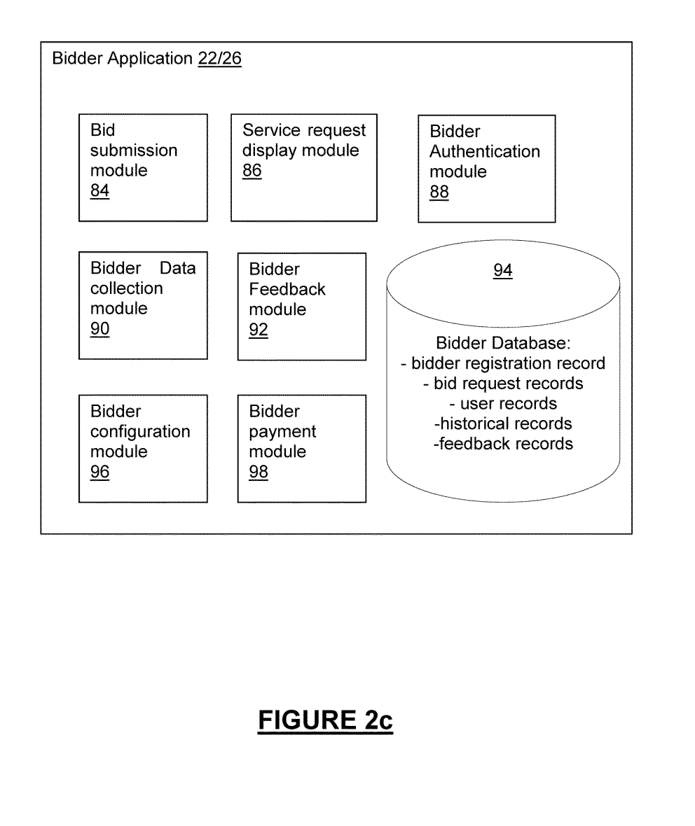

Application server 20 has a network interface in order to communicate with other components, to serve web pages, and perform other computing applications by connecting to network 24 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one application server 20 is shown for clarity, there may be multiple application servers 20 or groups of application servers 20 distributed over a wide geographic area and connected via e.g. network 24. Further details of application server will be described in relation to FIG. 2a.

User device 12 can generally be any suitable device for facilitating communication between the users and the application server 20 and is configured with a user application 18 installed on or running on the user device 12. User device 12 is operable by a user and may be any networked (wired or wireless) computing device including a processor and memory, such as a personal computer, workstation, server, portable computer, mobile device, personal digital assistant, laptop, smart phone, WAP phone, interactive television, video display terminals, gaming consoles, an electronic reading device, tablet, terminal, and portable electronic devices or a combination of these. Although only user device 12 is illustrated in FIG. 1, there may be more user devices 12 connected via network 24. User device 12 may include a user application 18 which may be a computing application, application plug-in, a widget, instant messaging application, mobile device application, e-mail application, online telephony application, java application, web page, or web object residing, executing, running or rendered on the user device 12 in order to access the functionality of application server 20, by providing and receiving data and carrying out actions and instructions, for example. User device 12 is operable by a user to, for example, submit a service request, interface with other devices associated with the user and item to be service (e.g. telematics devices located in a vehicle of a user), provide input data, receive output data, configure the application server 20 with user preferences, display visualizations of data received from application server 20, access data maintained by application server 20 or user device 12, provide feedback or ratings of service providers, and other functionality. User device 12 is operable to register and authenticate users (using a login, unique identifier, and password for example) prior to providing access to application server 20. User device 12 may be different types of devices and may serve one user or multiple users. The user device 12 may be connected to the application server 20 via any suitable communications channel. For example, the user device 12 may communicate to the application server 20 over a Local Area Network (LAN) or intranet, or using an external network. User device 12 may also have additional embedded components such as a global positioning system (GPS), a clock, a calendar, and so on. User device 12 may also be connected to and receive data from other devices that collect data regarding the user, service request, item to be serviced, and so on. For example, if the item to be serviced is a vehicle then the user device 12 may be connected to a navigation system, electronic mapping tool, satellite device, a diagnostic tool, tracking devices, radio device, receiver/transmitter/modem and other vehicle telematics devices. For example, a vehicle telematics device is a way of monitoring the location, movements, status, components and behaviour of a vehicle. Further details of user device 12 and user application 18 will be described in relation to FIG. 2b.

Service provider devices 14/16 can generally be any suitable device for facilitating communication between service providers and application server 20 and is configured with a bidder application 22/26. Service provider device 14/16 is operable by a service provider and may be any networked computing device including a processor and memory, such as a personal computer, workstation, server, portable computer, mobile device, personal digital assistant, laptop, smart phone, WAP phone, an interactive television, video display terminals, gaming consoles, an electronic reading device, tablet, and portable electronic devices or a combination of these. For example, a desktop computer device 14 and a mobile device 16 are shown in FIG. 1. Service provider devices 14/16 reside on the premises of the service provider or on location with the service provider, such as on board a tow truck. Although only two service provider devices 14/16 are illustrated in FIG. 1, there may be more service provider devices 14/16 connected via network 24. Service provider devices 14/16 may include a bidder application 22/26 which may be a computing application, application plug-in, a widget, instant messaging application, mobile device application, e-mail application, online telephony application, java application, web page, or web object residing, executing, running or rendered on the service provider devices 14/16 in order to access the functionality of application server 20, by providing and receiving data and carrying out actions and instructions, for example. Bidder applications 22/26 may be tailored to and optimized for particular service provider devices 14/16, such as for example a mobile bidder application 26 for a mobile service provider device 16 and a desktop bidder application 22 for a desktop computing service provider device 14. Service provider devices 14/16 operable by service providers to, for example, respond to a bid request with a bid (including an offer with the cost to service the item and the time for service), interface with other devices associated with the service provider, provide input data, receive output data, receive notifications, configure application server 20, display visualizations of data, access data maintained by application server 20 or service provider devices 14/16, provide feedback of users, and other functionality. User device 12 is operable to register service providers and authenticate service providers (using a login, unique identifier, and password, for example) prior to providing access to application server 20. Service provider devices 14/16 may be different types of devices and may serve one service provider or multiple service providers. For each, a service provider bid may be associated with locations received from global positioning systems associated with the service provider device 14/16 and a mapping interface on the user device 12 may show an icon associated with each bid and its location. The location on the mapping tool may be updated as the service provider device 14/16 changes location. Further details of service provider devices 14/16 and bidder applications 22/26 will be described in relation to FIG. 2c.

Network 24 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although not shown, application server 20, user device 12, and other components (not shown) may connect to network 24 via a firewall, which is a device, set of devices or software that inspects network traffic passing through it, and denies or permits passage based on a set of rules and other criteria. Firewall may be adapted to permit, deny, encrypt, decrypt, or proxy all computer traffic between network 24, application server 20, user device 12, service provider devices 14/16, and other components based upon a set of rules and other criteria. For example, firewall may be a network layer firewall, an application layer firewall, a proxy server, or a firewall with network address translation functionality. Network 24 is operable to secure data transmissions using encryption and decryption.

Referring now to FIG. 2a there is shown an application server 20 in further detail. Application server 20 has a processor and data storage device 70 storing instructions, the instructions being executable to configure the processor to provide a number of functional modules including: an application interface module 50, a service request module 52, a bid request module 54, a bid module 56, an authentication module 58, a comparison module 60, a notification module 62, a feedback module 66, and a recommendation module 68. A communication bus (not shown) enables asynchronous communication and data exchange between the application server 20 components. The components of the application server 20 are modular and can function independently or together.

Application server 20 generally includes one or more data storage devices 70 (e.g., memory, and the like), and could include a relational database (such as a SQL database), or other suitable data storage mechanisms. The data storage devices 70 are configured to store and maintain data records about the services offered by the service provider and the services requested by users, along with bidding data and so on. Data storage devices 70 may also store material related to services, users, items to be serviced, service providers, bids made by service providers, along with metadata about the services, users, items to be serviced, service providers, bids made by service providers, and attributes of the users, items to be serviced, and service providers. Data storage devices 70 are operable to store content for application server 20 such as content for provision to user applications 18 and bidder applications 22/26.

In some embodiments, the application server 20 may also have one or more backup servers that may duplicate some or all of the data stored on the data storage devices 70. The backup servers may be desirable for disaster recovery (e.g., to prevent undesired data loss in the event of an event such as a fire, flooding, or theft). In some embodiments, the backup servers may be directly connected to the application 20 but located at a different physical location.

Application interface module 50 is operable to interface with user application 18 and bidder applications 22/26 in order to provide data to user application 18 and bidder applications 22/26 and receive data from user application 18 and bidder applications 22/26. Application interface module 50 is operable to route data to data storage device 70 for storage and processing, and route requests and corresponding data to appropriate modules for processing.

Service request module 52 is operable to receive a service request from user application 18. The service request may include a user identifier, a location of the user or item to be serviced and a destination of the user or item to be serviced. The service request may also involve a requested service time, as bids may be vary depending on the service time. For example, at times where a service provider as excess capacity the cost for the service may be cheaper than a prime or busy time for the service provider. Service request module 52 is operable to receive additional service requests. For example, a first service request may relate to a tow for a vehicle and a second service request may relate to repair of the vehicle. Accordingly, a service request may relate to a service for a vehicle and may include a vehicle identifier and one or more known issues with the vehicle. The service request may also include telematics data for the vehicle, where the telematics data is received from a telematics device in communication with the user device 12 the service request was received from.

Bid request module 54 is operable to generate a bid request corresponding to the service request. Bid request module 54 is operable to determine a set of service providers to send bid requests based on various factors, such as for example, the type of service requested, the item to the serviced, the user, the location, the requested service time, and so on. For each of the plurality of service providers, bid request module 54 is further operable to receive a defined geographic area for the respective service provider. Bid request module 54 is operable to transmit a bid request to the respective service provider only if the location and the destination of the service request are within the defined geographic area for the respective service provider. If additional service requests are received, the bid request module 54 is operable to transmit additional bid requests corresponding to the additional service requests. A bid request module 54 is operable to request a bid from one or more service providers via bidder application 22/26, where each bid may include the cost for servicing the item and the time for service.

Bid module 56 is operable to receive a plurality of bids from bidder applications 22/26 where each bid comprises a service provider identifier for a corresponding service provider, a cost for service and a service time. The service provider identifier may be a unique code that identifies the service provider and associates the service provider with the bid made by the service provider. Additional information regarding the service provider may also be transmitted to the bid module 56 such as, for example, a location of the service provider, along with real time updates of the location as the service provider changes location. This location data may be received via a GPS and may be used to populate a mapping tool presented as an interface on the user devicel2. Bid module 56 is operable to transmit the received bids to the user application 18 and receive a selected bid in response. Bid module 56 is operable to generate an additional bid based on the received bids and transmit the additional bid as part of the bids received from service providers. The selected bid may be the additional bid. An organization operating application server 20 may also be a service provider. The organization may review all received bids before providing the bids to the user and include an additional bid (such as offering a lower cost than the received bids, or reduced time than the received bids) if it may perform that service. The organization may be limited to specific geographic areas and may only be able to provide additional bids on service requests particular to those geographic areas. If more than one service request is submitted then bid module 56 is operable to receive additional bids from the same or different service providers, and receive a selected additional bid.

Authentication module 58 is operable to authenticate each service provider and each user. In some examples, a user may be required to authenticate their identities in order to communicate with the application server 20 and user application 18. For example, each of the users may be required to input a user identifier such as a unique code, login name, and/or a password associated with that user, or otherwise identify the user to gain access to the application server 20 (and user application 18). Similarly, a service provider may be required to authenticate their identities in order to communicate with the application server 20 and bidder applications 22/26. For example, each of the service providers may be required to input a service provider identifier such as a login name, and/or a password associated with that service provider or otherwise identify themselves to gain access to the application server 20 (and bidder application 22/26). Authentication module 58 may ensure that a legitimate user is request service and that legitimate service providers are bidding on requested services. In some examples, one or more users (e.g., “guest” users) or service providers may be able to access the system without authentication. Such guest users or service providers may be provided with limited access and may not be able to perform specific actions, such as submit service requests or bids. Authentication module 58 may be further operable to generate authentication data in relation to a selected bid to ensure the legitimate server provider shows up to provide the requested service. For example, authentication module 58 may provide a unique barcode to service provider associated with the selected bid for display on service provider device 16. When the service provider arrives at the user location then the user application 18 may provide a scanning tool to scan the barcode displayed on service provider device 16 and provide the scanned data to authentication module 58 to perform a matching to the unique barcode of service provider associated with the selected bid to the to confirm that it is the legitimate service provider onsite. Other onsite authentication mechanisms may also be used such as a passcode, photo, and so on. The authentication module 58 is operable to provide onsite authentication data to bidder application (where the onsite authentication data is linked to a service request identifier), receive onsite authentication data from user application 18 in relation to a specific service request (associated with the service request identifier) and provide a notification indicating whether the authentication was successful or not. Authentication module 58 may store a plurality of records associated with service requests and selected bids where each record may be retrieved using a service request identifier or data indicating a barcode or other authentication mechanism for the selected service provider. This may help a user avoid getting service by an illegitimate service provider pretending to be the selected service provider after receiving location details from the bid request and information regarding the selected bid.

Comparison module 60 is operable to provide a price range for a reasonable bid for the location and destination to the user application 18. Comparison module 60 is operable to provide a price range for a reasonable bid for the requested service time to the user application 18. Comparison module 60 is operable to compute the price range based on at least one of historical data for similar service requests and industry standards. Accordingly, comparison module 60 is operable to request data from data storage device 70 such as historical records and industry/statistical records in order to generate. For example, the service request may relate to a tow for a vehicle and application server 20 is configured to perform calculations that determine “from point A to point B you should pay $X.” This can help the user identify if they are getting reasonable bids from the service providers or if they are getting ripped off.

Notification module 62 is operable to send a notification to the bidder application 22/24 corresponding to the selected bid. The notification may indicate to a service provider associated with a bidder application 22/24 that their bid was selected. Further, notification module 62 is operable to send a notification to each of the remaining services providers indicating that their bid was not selected, and may optionally indicate details of the selected bid, such as the selected service provider, the price of the selected bid, the time of the selected bid and so on.

Feedback module 66 is operable to receive feedback data from users in relation to one or more service providers and provide the received feedback data to data storage device 70 for storage as feedback records. Feedback module 66 is operable to receive feedback data from service providers in relation to one or more users and provide the received feedback data to data storage device 70 for storage as feedback records. Feedback module 66 is further operable to generate feedback reports specific to a user or service provider by interacting with data storage device 70 to retrieve and aggregate feedback records specific to a user or service provider. For example, a when multiple bids from service providers are transmitted to user application 18 a feedback summary report for each of the service providers may be included along with the bids to assist in selecting a bid.

Recommendation module 68 is operable to provide recommended service providers to user application 18. The recommendation may relate to one or more of the service providers a bid was received from for a service requested by the user. The recommendation may also relate to a different service provider and a different service than requested by the user, such as a complementary service. For example, if a user requests a tow for a vehicle from a current location to a destination then recommendation module 68 may recommend a garage located proximate to the destination or current location to repair the vehicle.

Configuration module 64 is operable to provide configuration or preference options to user application 18 and bidder application 22/26 and receive configurations in response. The configurations received from user application 18 and bidder application 22/26 may be stored by data storage device 70 as part of user records and bidder records, respectively. For example, the user may configure how received bids are organized, such as by time and cost. As another example, the service provider may configure which service request they receive notification for, such as based on geographic location, for example. The service provider may be a tow operator and they may input their companies' typical coverage as a configuration and only bid requests that fit within their defined geography would be sent to the tow operator. As a further example, a user may configure preferred service providers (e.g. service providers that they would like to receive service or bids from) and may also configure a blacklist of service providers (e.g. service providers that they would not like to receive service or bids from).

Payment module 69 is operable to process payments for services arranged by application server 69. Payment module 69 is operable to prompt user application 18 (and user) for payment based on a selected bid prior to or after receiving the service requested. Payment module 69 is operable to receive payment details from user application 18 and process the payment or engage a third party payment platform to process the payment. Payment module 69 is operable to provide payment to the service provider associated with the selected bid who is providing the service or engage the third party payment platform to provide payment to the service provider. Payment module 69 is operable to notify bidder application 22/26 regarding received payments. Payment module 69 is operable to charge the user or the service provider an administration fee for using the service and may add or deduct the administration fee from the payment.

Data storage device 70 is operable to store and manage data records for use by application server 20. Some or a portion of data records may also be accessible via a user application 18, bidder application 22/26 or both. Example data records include service request records, user records, bid records, service provider records, historical records, industry records (including statistical data), and feedback records.

Service request records include details of service requests received from application server, including the user associated with the service request, the service provider associated with the selected bid for the service request, type of service requested, data collected from the user regarding the service request such as time, date, location, destination, issues with vehicle or other item requiring service, and so on. User records include information regarding users, such as usernames (or other user identifiers), password(s), home address, work address, phone number, vehicle information (or information regarding other items to be serviced), preference information (such as preferred service providers), and so on. Service provider records include information regarding service providers, such as company name, identifier, password(s), address, information regarding type of service, geographic area for providing service, and so on. Bid records include information collected regarding bids received in response to specific service/bid requests including an indication of the selected bid. Historical records include historical data in relation to service providers, users (e.g. demographic data), services, bids (including the selected bids, aggregated bid data and so on) that may be processed by application server 20 to provide a reasonable price range to a user for similar service requests, and so on. Industry records (including statistical data) include information regarding services, service providers, and so on that may be processed by application server 20 to provide a reasonable price range to a user for similar service requests, and so on. Feedback records include feedback data received from users regarding service providers or received from service providers regarding users, and so on. Feedback records may also include third party data such as reviews, ratings, etc. Feedback data may be processed by application server 20 to provide recommendations to user in relation to service providers, and so on. Service request records may also include onsite authentication data specific to service requests in order to validate the service provider onsite.

Data storage device(s) 70 may also store authorization criteria that define what actions may be taken by the users (via user application 18) and service providers (via bidder applications 22/26). The authorization criteria may be included in user records or service provider records. In some embodiments, the authorization criteria may include at least one security profile associated with at least one role to differentiate between different types of users and service providers. Users with a specific role may have a security profile that allows them to configure the service request and user preferences, and so on. Service providers with a specific role may have a security profile that allows them to configure the bids and service provider preferences or configurations, and so on.

In some embodiments, some of the authorization criteria may be defined by specific users who may or may not be requesting bids. For example, administrator users may be permitted to administer and/or define global configuration profiles for the system 10, define roles within the system 10, set security profiles associated with the roles, and assign the roles to particular users and service providers of the system 10. In some cases, the administrative users may use another computing device and an administrative application to accomplish these tasks.

Referring now to FIG. 2b there is shown a block diagram of a user application 18 for submitting service requests and selecting a bid from a service provider according to one or more embodiments. User application 18 may be a computing application, application plug-in, a widget, instant messaging application, mobile device application, e-mail application, online telephony application, java application, web page, or web object residing, executing, running or rendered on the user device 12 in order to access the functionality of application server 20. User application 18 may be implemented by a processor of the user device 12 executing instructions stored on a data storage device of the user device 12.

User application 18 may include a number of functional modules such as user service request module 72, bid selected module 74, user authentication module 76, data collection module 78, user feedback module 80. User application 18 may provide a user interface for receiving and display data to user. User application 18 is operable to communicate and exchange data with application server 20 and bidder applications 22/26. A communication bus (not shown) enables asynchronous communication and data exchange between the user application 18 components. The components of the user application 18 are modular and can function independently or together. The user device 12 may include a touch screen or other input/output mechanism in order for user to interact with user application 18.

User service request module 72 is operable to provide a service request form to receive input data and generate a service request for provision to application server 20. The user service request module 72 may access service request records in user database 82 to automatically populate the service request form. For example, the most recent service request data or the most frequent service request data may be automatically populated.

User service request module 72 may receive input data for different types of service requests. User service request module 72 is operable to validate a service request to ensure it contains sufficient information and is of proper format prior to sending the service request to the application server 20. User service request module 72 is operable to interact with data collection module 78 to collect data for the service request, such as for example data regarding the item to be serviced. For example, the service request may relate to a tow for a vehicle and the service request may include data describing the vehicle and known problems with the vehicle, as received from telematics devices of the vehicle, and so on.

Bid selection module 74 is operable to provide a bid selection form displaying all bids received from bidders in response to a service request. Bid selection module 74 is then operable to receive a selected bid and provide the selected bid to application server 20.

User authentication module 76 is operable to authenticate a user (using a login and password for example) of the user application 18 prior to providing access to the functionality provided by user application 18. Further, the same user application 18 may serve one user or multiple users, and authorization provides a mechanism to distinguish between the multiple users. Authentication may ensure that a legitimate user is requesting service. In some examples, one or more users (e.g., “guest” users) may be able to access the user application 18 without authentication. Such guest users may be provided with limited access and may not be able to perform specific actions, such as submit service requests or select bids. User authentication module 76 may be further operable to perform onsite authentication of a service provider to confirm the service provider that arrives to the location of the user is actually the winner of the bid. As noted, this may be accomplished through a barcode to be scanned from the service provider device 16 by the user (reconciliation) or via a pin or pass number provided by the service provider device 16 and confirmed by the user authentication module 76. A scanning tool may be provided by user authentication module 76 to receive the authentication data from the service provider device 16.

Data collection module 78 is operable to receive data collected by user device 12 such as data collected via a global positioning system, a clock, a calendar, or other components of the user device 12. Data collection module 78 is operable to receive data collected by user device 12 from devices in communication with user device 12 such as a navigation system, a diagnostic tool, vehicle telematics devices, and so on.

User feedback module 80 is operable to receive feedback data from users in relation to one or more service providers and provide the received feedback data to application server 20. The user feedback module 80 may provide a questionnaire, a like/dislike icon, a star rating, form field or other mechanism to receive feedback regarding a service provider. User feedback module 80 is operable to receive feedback reports regarding service providers (such as service providers that bids are received from) from feedback module 66 of application server 20, and display those feedback reports to user. For example, when multiple bids from service providers are displayed by user application 12 a feedback summary report for each of the service providers may be included along with the bids to assist in selecting a bid. The feedback reports may include feedback received from other users or may be specific to a user.

User configuration module 81 is operable to provide configuration or preference options and receive selected configurations in response. User configuration module 81 may receive updates for configuration options from configuration module 64 of application server 20. User configuration module 81 is operable to provide configurations received from user to configuration module 64 of application server 20 where they may be stored by data storage device 70 as part of user records. For example, the user may configure how received bids are organized, such as by time and cost. As a further example, a user may configure preferred service providers (e.g. service providers that they would like to receive service or bids from) and may also configure a blacklist of service providers (e.g. service providers that they would not like to receive service or bids from). User configuration module 81 is operable to store received configurations locally in user database 82.

User payment module 83 is operable to display a payment form for receiving payment details to pay for the requested service prior to or after receiving the service. User payment module 83 is operable to provide the received payment details to payment module 69 of application server 20 for processing, to bidder application 22/26 for processing by service provider, or to engage a third party payment platform to process the payment.

A user database 82 may contain data stored locally on the data storage device of user device 12 or may be otherwise accessible by the user application 18. The amount of data saved in the user database 82 may be constrained based on the amount of user device 12 memory allocated for the user application 18. The user database 82 may contain a registration record of data that may be automatically provided to application server 20 to authenticate the user (such as a digital certificate, username, password, and so on. The user database 82 may contain service request records of types of services requested, saved service requests, frequently used service requests, or recently used service requests for automatic provision to application server 20 to avoid reentering the data for each service request manually. User database 82 may also contain historical records regarding selected bids, frequently used service providers, user data, preferred service providers, recent locations, frequently requested service types, and so on. User database 82 may also include feedback records of reviews, ratings and feedback received from user to provide user preferences. User database 82 may also include data regarding item(s) to be serviced, such as a vehicle for example, which may include global positioning data, navigation data, telematics data, diagnostic data, and so on. These are examples only and some data records may not be stored on user device 12 especially if there is limited memory available on the data storage device of the user device 12. Further, some or all data records may instead or additionally be stored on data storage device 70 of application server and may be accessible to user application 18.

Referring now to FIG. 2c, there is shown a block diagram of a bidder application 22/26 for submitting bids by service providers according to one or more embodiments. Bidder application 22/26 may be a computing application, application plug-in, a widget, instant messaging application, mobile device application, e-mail application, online telephony application, java application, web page, or web object residing, executing, running or rendered on the service provider device 14/16 in order to access the functionality of application server 20. Bidder application 22/26 may be implemented by a processor of the service provider devices 14/16 executing instructions stored on a data storage device of the service provider device 14/16. Bidder application 22/26 may include a number of functional modules such as bid submission module 84, service request display module 86, bidder authentication module 88, bidder data collection module 90, bidder feedback module 92, and a bidder database 94 of bidder related data records. Bidder application 22/26 may provide a bidder interface for receiving and display data to service providers. Bidder application 22/26 is operable to communicate and exchange data with application server 20 and user device 12. A communication bus (not shown) enables asynchronous communication and data exchange between the bidder application 22/26 components. The components of the bidder application 22/26 are modular and can function independently or together.

Bidder application 22/26 may be tailored or customized for various types of service provider devices 14/16. For example, a mobile bidder application 26 may be optimized for a mobile service provider device 16 in terms of display size, processing requirements, and memory requirements. As another example, a desktop bidder application 22 may be optimized for a desktop service provider device 14.

Service request display module 86 is operable to display data regarding service requests (bid requests), such as a user identifier, location, and destination. For example, service request display module 86 is operable to display a mapping interface showing a location and destination associated with the service request. Further, service request display module 86 is operable to display additional data regarding the service request (bid request) or request additional information if required. For example, the service request (bid request) may relate to a tow for a vehicle and the service request may include information regarding the vehicle and known problems with the vehicle. The service request display module 86 may also indicate if the same user has previously made a service request, along with the nature of the service request and the selected bid. Further, the service request display 86 may indicate if the user associated with the service request is a previous customer of the service provider, when the customer was last serviced, and so on, to provide additional context for the service provider. Service request display module 86 may optionally provide a notification alerting a service provider to a new incoming service request (bid request).

Bid submission module 84 is operable to provide a bid form to receive data regarding the bid for the service request (bid request). Bid submission module 84 may access service request records in bidder database 94 to automatically populate the bid form. For example, the most recent similar bid or the most frequent bid may be automatically populated. Bid submission module 84 may receive input data for bids for requests for different types of services. Bid submission module 84 is operable to validate a bid prior to sending the bid to the application server 20 to ensure it contains sufficient information and is of proper format. Bid submission module 84 is further operable to alert the service provider using the bidder application 22/26 if their bid was selected. Further, bid submission module 84 is operable to alert the service provider using the bidder application 22/26 if their bid was not selected and may indicate details of the selected bid.

Bidder authentication module 88 is operable to authenticate a service provider (using a login and password for example) of the bidder application 22/26 prior to providing access to the functionality provided by bidder application 22/26 and application server 20. Further, the same bidder application 22/26 may serve one service provider or multiple service providers, and authorization provides a mechanism to distinguish between the multiple service providers. Bidder authentication module 88 may ensure that a legitimate service provider is bidding on a service request. In some examples, one or more service providers (e.g., “guest” service providers) may be able to access the bidder application 22/26 without authentication. Such guest service providers may be provided with limited access and may not be able to perform specific actions, such as submit bids in response to service requests. Bidder authentication module 88 may be further operable to enable onsite authentication of a service provider to confirm the service provider that arrives to the location of the user is actually the winner of the bid. As noted, this may be accomplished through a barcode to be scanned from the service provider device 16 by the user (reconciliation) or via a pin or pass number provided by the service provider device 16 and confirmed by the user authentication module 76 or authentication module 58. Accordingly, bidder authentication module 88 is operable to receive onsite authentication data from authentication module 58 or user authentication module 76 to display, transmit, or otherwise provide to user application 18 when service provider arrives onsite at the service location. In addition, bidder authentication module 88 may store a unique authentication data associated with the service provider and transmit to user authentication module 76 upon its bid being selected (via authentication module 58 or directly to user application 18). This unique authentication data may then be presented to the user authentication module 76 onsite to authenticate the service provider when they arrive to provide the requested service.

Bidder data collection module 90 is operable to receive data collected by service provider device 14/16 or by the service provider using bidder application 22/26. For example, bidder data collection module 90 is operable to receive data regarding various locations associated with the service provider for provision to other modules, such as the service request display module 86 to alert the service provider if the service request relates to a location proximate a location of the service provider. Bidder data collection module 90 is operable to receive data collected by devices in communication with service provider device 14/16 such as a navigation system, a diagnostic tool, vehicle telematics devices, fleet management system, and so on.

Bidder feedback module 92 is operable to receive feedback data from service providers in relation to one or more users of the service request and provide the received feedback data to application server 20. Bidder feedback module 92 may provide a questionnaire, a like/dislike icon, a star rating, form field or other mechanism to receive feedback regarding a user. Bidder feedback module 92 is operable to receive feedback reports regarding users (such as users that service requests are received from, or users known to have committed fraud, not paid for the service, or other wrongdoing) from feedback module 66 of application server 20, and display those feedback reports to service provider. For example, when a service request is displayed by bidder application 22/26 a feedback summary report for the user may be included along with the service request to assist in responding with a bid. The feedback reports may include feedback received from other service providers or may be specific to a service provider.

Bidder configuration module 96 is operable to provide configuration or preference options and receive selected configurations in response. Bidder configuration module 96 may receive updates for configuration options from configuration module 64 of application server 20. Bidder configuration module 96 is operable to provide configurations received from service providers to configuration module 64 of application server 20 where they may be stored by data storage device 70 as part of service provider records. For example, the service provider may configure which service requests they receive notification of, such as based on geographic location for example. Bidder configuration module 96 is operable to store received configurations locally in bidder database 94.

Bidder payment module 98 is operable to display a payment form for receiving payment details from service provider in accordance with embodiments where service providers must pay an administration fee to use service. Alternatively, the administration fee may be deducted from payments received by payment module 69 of application server prior to distributing the payment to the service provider. Bidder payment module 98 is operable to provide payment details to payment module 69 of application server 20 to process the payment or to engage a third party payment platform to process the payment. Payment module 69 is operable to provide payment to the service provider associated with the selected bid who is providing the service or engage the third party payment platform to provide payment to the service provider. Payment module 69 is operable to notify bidder application 22/26 regarding received payments. Payment module 69 is operable to charge the user or the service provider an administration fee for using the service and may add or deduct the administration fee from the payment.

Bidder database 94 may store, retrieve and update bidder related data records. Bidder database 94 may contain data stored locally on the data storage device of service provider device 14/16 or may be otherwise accessible by the bidder application 22/26. The amount of data saved on the bidder database 94 may be constrained based on the amount of service provider device 14/16 memory allocated for the bidder application 22/26. Bidder database 94 may contain a bidder registration record of data that may be automatically provided to application server 20 to authenticate the service provider (such as a digital certificate, username, password, and so on). Bidder database 94 may contain bid request records of types of services provided by service provider, saved bid requests, recently or frequently responded to similar bid requests for automatic provision to bid submission module 84 for entering into bid form to avoid manual reentering of data for each bid request, for consistency and as a reminder. Bidder database 94 may also contain historical records regarding submitted bids, selected bids, frequently used service providers, service provider data, preferred users, locations, frequently requested service types, and so on. Bidder database 94 may also include feedback records of reviews, ratings and feedback received from service provider or about service provider (and received from users). Bidder database 94 may also include data regarding item(s) to be serviced, such as a vehicle for example, which may include global positioning data, navigation data, telematics data, diagnostic data, and so on. These are examples only and some data records may not be stored on service provider device 14/16 especially if there is limited memory available on the data storage device of the service provider device 14/16. Further, some or all data records may instead or additionally be stored on data storage device 70 of application server and may be accessible to bidder application 22/26.

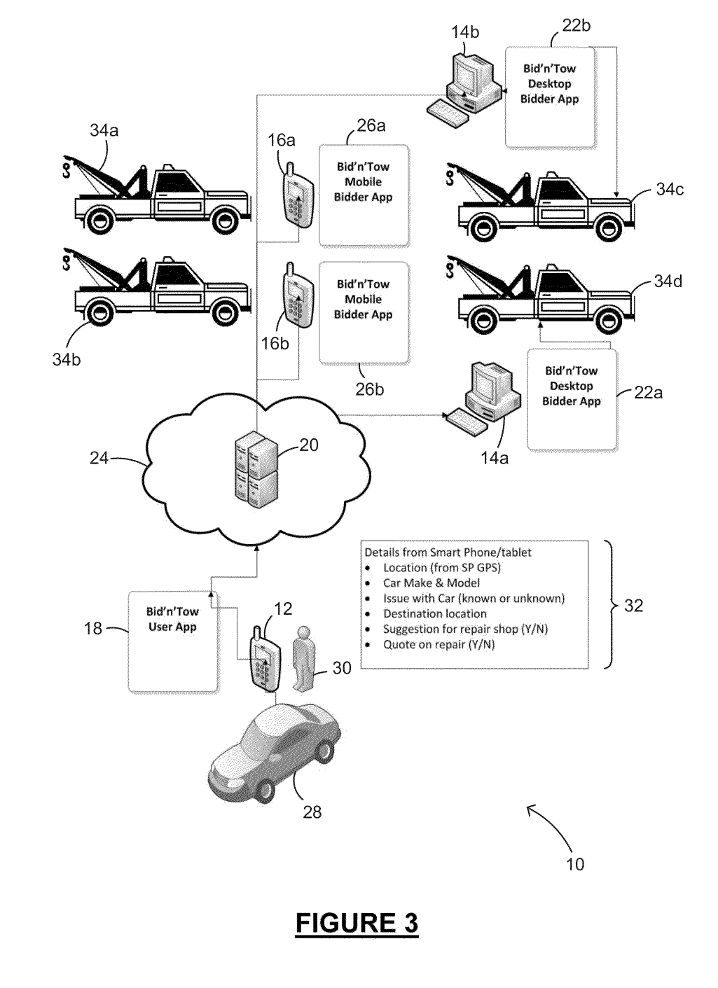

Reference is now made to FIGS. 3 to 6 for an illustrative example where the service requested is a tow for a vehicle and the service providers are tow truck operators. This is an example only and other service may be requested such as taxi cabs, vehicle repairs, massage therapy, spa services, appliance repairs, house repairs, and so on.

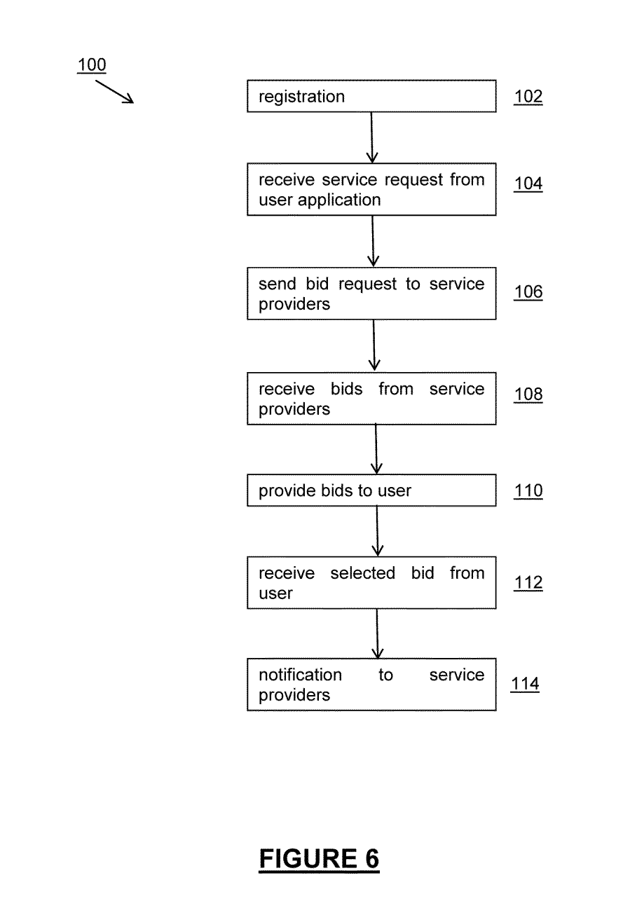

FIG. 6 illustrates a flow chart diagram of a method 100 for submitting service requests and selecting bids from service providers according to one or more embodiments.

At 102, registration information is received from users and service providers. A user or service provider may be required to create an account or login to an existing account. For the illustrative example, the service providers may be tow companies that subscribe to the service provided by application server 20. This subscription would allow tow companies to bid on towing service if a customer breaks down and alert the tow companies of the service request. The service providers may subscribe or register for the alert and bidding system by downloading bidder application 22/26 onto service provider device 14/16 and registering for the service by providing the required information, such as company name, address, email, phone number, types of services provided and so on. Alternatively, a service provider can register via a web interface to application server 20. The service provider may be required to create a service provider account accessible via a service provider identifier (e.g. username and password) in order to authenticate with application server 20. When a service provider registers a unique barcode, passcode, or other authorization mechanism may be linked to the specific service provider and stored by bidder application 22/26 for use in onsite authorization of the service provider. Bidder application 22/26 provides the received registration data to application server 20 for storage at data storage device 70 and may locally store the registration data in bidder database 94. Application server 20 is operable to store the registration data as part of service provider records and user records. The service provider record may include the authorization data for the service provider.

A user may subscribe or register for the service by downloading user application 18 to user device 12 and providing the required information, such as name, address, phone number, vehicle details, and so on. Alternatively, a user can register via a web interface to application server 20. The user may be required to create a user provider account accessible via a user identifier (e.g. username and password) in order to authenticate with application server 20. User application 10 provides the received registration data to application server 20 for storage at data storage device 70 and may locally store the registration data in user database 82.

At 104, once the user has logged in to user application 18, then the user may submit a service request by inputting data for the service request at user application 18. The service request is received by application server 20 from user application 18. The service request may include a user identifier identifying the requesting user, a location of the item to be serviced, and a destination for the item to be serviced. For example, in the event of a vehicle break-down the user would open the user application 18 on their user device 12. Their user device 12 may have GPS hardware/software (or other location determination device) and the user application 18 would automatically interact with the GPS to obtain location information and send the location information to the application server 20. Using the user application 18, the user can verify the location determined by the GPS and enter a tow destination. The user may also enter any known issue with the vehicle and identify if the vehicle should be taken to a garage or home. The user device 12 may interface and connect with telematics devices of the vehicle so that user application 18 can receive information from the vehicle via a connector through the user device 12 (e.g. Bluetooth, WiFi and so on). The vehicle information may also include a make and model of the car. The user may configure the user application 18 for various cars and chose the correct vehicle from a drop down menu of the user application 18. The service request may relate to multiple services, such as a tow service and a garage service, for example. The destination may be general, such as a city or a region, or may be specific such as a street address. Application server 20 is operable to authenticate the user based on a user identifier prior to receiving a service request. Application server 20 is operable to store the service request in data storage device 70 as part of service request records. The user may also have default information or favorite locations to automate submission of data for service request.

Referring now to FIG. 3 there is shown a block diagram of an example embodiment of system 10 used in a towing context for receiving a service request according to one or more embodiments. The system 10 is shown to include an application server 20 connected to user application 18 on a user device 12 and bidder applications 22/26 on service provider devices 14/16 via network 24. The user 30 with a vehicle 28 break-down will submit a service request for a tow for the vehicle 28. In this example, the service request may include service request related data 32, such as for example, the type of service requested (tow in this example), the location of the vehicle, make and model of the vehicle, issues with the vehicle (which may be received from telematics devices), destination location, a requested service time (e.g. immediate, Wednesday afternoon, anytime Thursday, and so on) whether the user would like a suggestion for a repair service (in addition to tow service), whether the user would like a price quote for a repair service, and so on. The user application 18 is operable to provide the received service request to application server 20. The user application 18 may locally store details of the service request in user database 82.

At 106, upon receiving the service request, the application server 20 is operable to generate a bid request and send the bid request to service providers in order to solicit bids. Application server 20 is operable to generate a set of service providers to send the bid request based on the type of service requested, the location of the vehicle 28, the destination, the user 30, and so on. The application server 20 may query the data storage device 70 and the service provider records stored thereby to generate the set of service providers to send the bid request to. In some instances, bid request may be used interchangeably herein with service request. Application server 20 is further operable to, for each of the plurality of service providers, receive a defined geographic area for the respective service provider, and transmit the bid request to the respective service provider only if the location and/or the destination of the service request are within the defined geographic area for the respective service provider. For example, if the vehicle is located in Toronto then application server 20 may only send the bid request to service providers in Toronto or proximate to Toronto. A service provider can indicate via configurations or preferences specific geographical locations they would like to receive bid requests for. The bid request may contain some or all of the information from the service request. The bid request is sent from the application server 20 to the set of service providers via the bidder applications 22/26 on service provider devices 14/16.

Referring back to FIG. 6, at 108, the service providers submit bids for the service request in response to receiving the bid request. A service provider may submit a bid using the bidder application 22/26 on a service provider device 14/16. A bid may include a cost for providing the service and a time estimate for providing the service, such as an estimated time until the tow driver would arrive at the vehicle 28. In accordance with some embodiments, each of the service providers may be authenticated based on the service provider identifier prior to submitting a bid to ensure the service provider is legitimate. Application server 20 is operable to store received bids in data storage device as part of bid records, including an association between each bid and corresponding service provider.

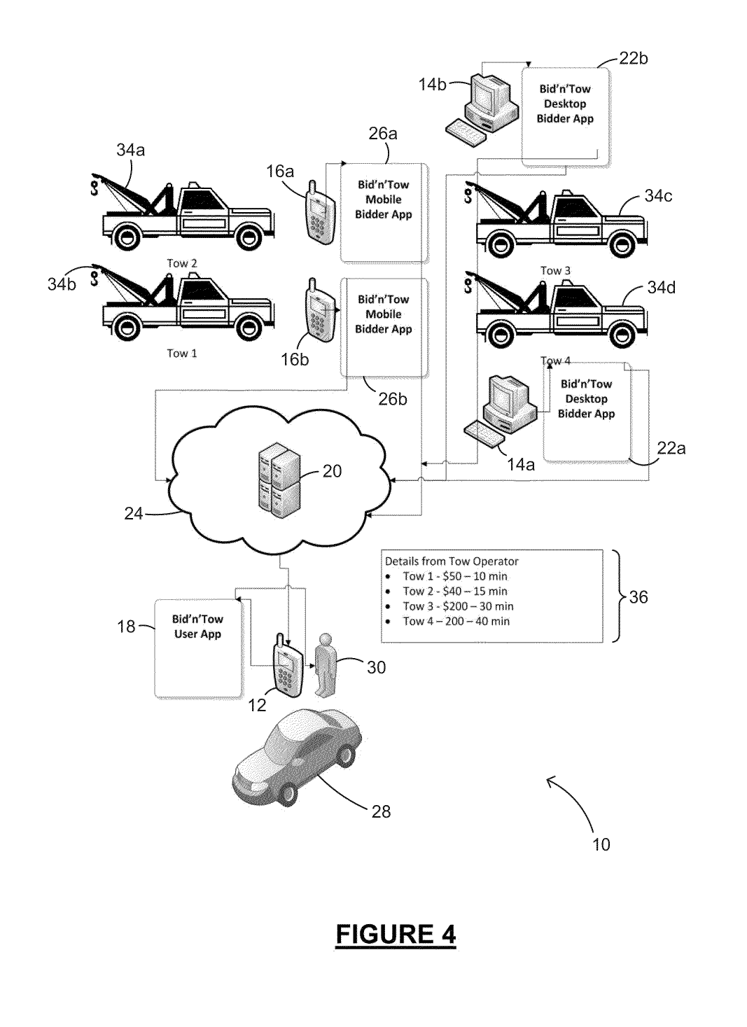

Referring now to FIG. 4, there is shown a block diagram of an example embodiment of system 10 used in a towing context for receiving bids from service providers and providing bids in response to a bid request according to one or more embodiments. In this example, tow truck drivers 34 operate bidder applications 22/26 on service provider devices 14/16 to submit bids. In this example, the following four bids 36 are received at application server 20 from tow truck drivers 34: #1 tow truck 34b $50 and 10 minutes, #2 tow truck 34a $40 and 15 minutes, #3 tow truck 34c $200 and 30 minutes, and #4 tow truck 34d $200 and 40 minutes. In this non-limiting example the service times are defined as the time until the service will be provided, but it may also be defined as a date/time, such as Wednesday at 3:30 pm, or otherwise defined. The bids are collected by application server 20 for provision to user application 18. Application server 20 may reformat the bids prior to provision to user application 18, may remove sensitive data, and so on.

Referring back to FIG. 6, at 110, application server 20 transmits received bids to user application 18 on user device 12 for review by user. Application server 20 may transmit bids on a rolling basis as they are received, may wait to transmit bids until a threshold number of bids have been received, may wait to transmit bids for a particular amount of time, and so on. An administrative user of application server 20 may review bids as received and may place an additional bid for the service request. For example, an organization may offer the bidding service provided by application server 20 and may place a competitive bid that has a lower price or reduced time than the other bids for provision to user. That is, application server 20 is operable to generate an additional bid in view of the received bids and transmit the additional bid as part of the plurality of bids, where the additional bid may be selected by the user. Application server 20 is operable to provide reviews of service providers that bids are received from, such as reviews based on received feedback stored in data storage device 70, in order to assist the user in making a bid selection. In accordance with some embodiments, instead of transmitting the bids to the user, application server 20 is operable to generate a response to the service request based on the received bids, where the response may include an automatically selected service provider or an additional bid made by the organization operating the application server 20 that is competitive in view of the received bids. The bid may also indicate additional criteria, such as for example, whether the service provider has criteria the ability to service the vehicle. A service request may only request a tow but a bid in response may offer additional services that may complement the initial requested service. A service request may also request multiple services (e.g. a tow and service for a vehicle) and a bid may respond by offer a cost and time for some or all requested services. This may not happen in all cases but if the tow operator had connections at a garage the service provider could offer tow and service. Receiving bids for additional services may be an optional item to be set by the user, for example.

User application 118 is operable to provide an interface to display the received bids to user. The bid results may be organized by time or cost based on user preference. The bids may also be displayed as icons on a mapping tool to indicate a location for each service provider a bid is received from. Application server 20 is operable to keep track of similar bids in similar areas to provide users with a best price range. If a best price range based on historical data is not available then application server 20 is operable to calculate the distance and provide a price based on industry standards. Providing a price range based on historical data or a price based on industry standards educates the user on realistic costs and assists the user in selecting a bid. That is, application server 20 is operable to provide a price range for a reasonable bid for the location and destination, wherein the price range is based on at least one of historical data for similar service requests and industry standards.

At 112, user selects a bid using an interface provided by the user application 18 and the user application 18 in turn provides the selected bid to application server 20. Application server 20 is operable to store the selected bid in data storage device as part of bid records. Similarly, user application 18 is operable to locally store the selected bid as part of historical records. The service provider associated with the selected bid may have service provider device 14/16 (with GPS and bidder application 22/26) in the tow truck or may have another device with a GPS in communication with application server 20 in the tow truck to provide real-time location data for the service provider associated with the selected bid. User application 18 may provide a mapping interface showing the real-time location of the service provider. When a user selects a bid then application server 20 is operable to transmit onsite authentication data to the service provider device 22/26 for use in authenticating the service provider when they meet the user at the service location. Application server 20 may also send onsite authentication data to the user application 18 to verify the service provider (or user).

At 114, application server 20 is operable to transmit notifications to the bidder applications 14/16 on the service provider devices 22/26. Application server 20 is operable to transmit a notification to the service provider corresponding to the selected bid indicating that their bid was selected. In some embodiments, the onsite authentication data may be transmitted to the service provider along with the notification that there bid was selected. The onsite authentication data may be specific to each selected bid or the same onsite authentication data may be used by the same service provider for all selected bids associated with that service provider. In the latter case, the notification may not include the onsite authentication data. The user application 18 may also directly transmit the onsite authentication data to the service provider device 22/26 of the selected service provider directly. Application server 20 is operable to transmit a notification to each of the remaining services providers, indicating that their bid was not selected and the price or other details of the selected bid.

When a selected service provider arrives onsite to provide the service, the service provider application 26 may provide the onsite authentication data to the user application 18, such as via a barcode scan, protected message transmission, passcode, and so on. The user application 18 may verify the onsite authentication data or may send the onsite authentication data to the application server 20 for verification. In response, the application server 20 is configured to verify the onsite authentication data by performing a matching to stored onsite authentication data and send a notification to the user application 18 indicated whether the authentication was successful or not.

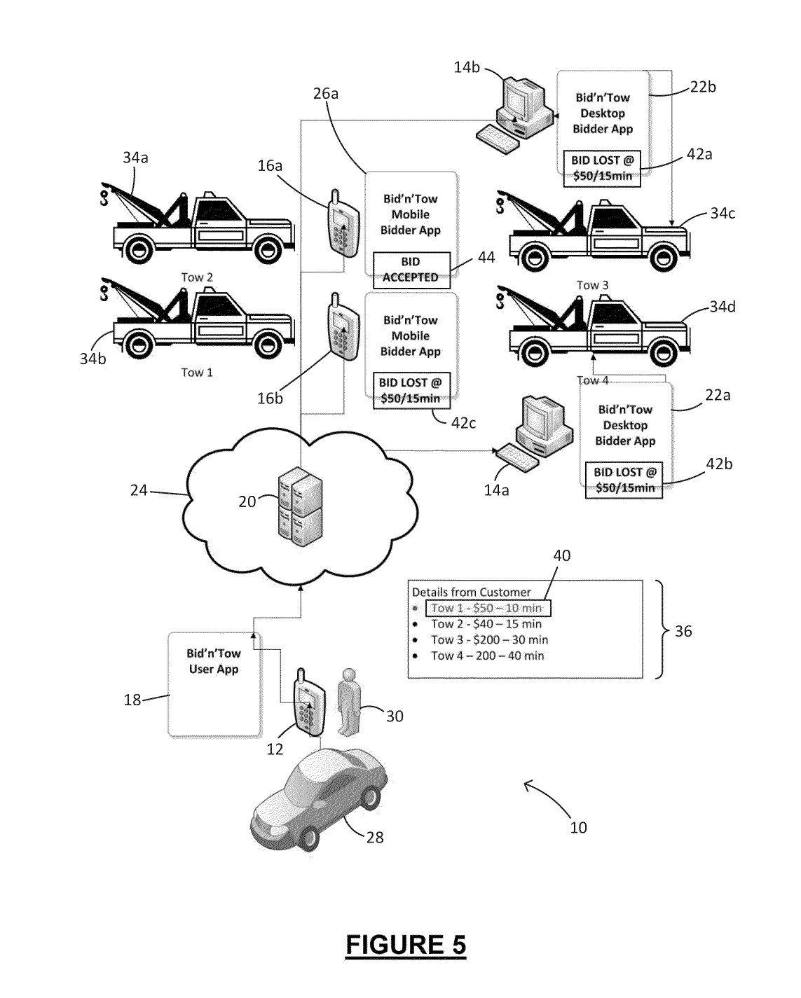

Referring now to FIG. 5, there is shown a block diagram of an example embodiment of system 10 used in a towing application for receiving a selected bid request according to one or more embodiments. As shown, the user selects the bid received from #1 tow truck 34b of $50 and 10 minutes. A notification 44 is sent to the winning tow truck 34b indicating that their bid was accepted. Notifications 42a, 42b, 42c are also sent to the other two trucks 34a, 34c, 34d indicating that their bid was not selected and the details (time, cost) of the selected bid. This may assist the tow truck drivers in making competitive bids next time a bid request is received for a service request.

The service request may indicate two requested services or a second service request may be received from the user. For example, the service request may request a tow for a vehicle from a tow truck operator and may also request repair for the vehicle from a local garage. The tow truck operator and the local garage may be part of the same organization, related organizations, or independent organizations. Application server 20 is operable to query for garages in the area that subscribe to the service. Application server 20 is operable to query for garages located within a pre-entered radius. Application server 20 is operable to transmit another bid request to garages to bid on repairs for known problems with the vehicle via telematics or vehicle history. Further, the same service provider may bid on both the requested services, such as both a tow and a repair. Accordingly, application server 20 is operable to receive a second service request or a service request containing two requested services from user application 18. The user request may contain sufficient information about the vehicle and problems therewith to enable a garage or other service provider to bid on the repair. Application server 20 is operable to transmit a second bid request corresponding to the second service request. Application server 20 is operable to receive additional bids from bidder applications 14/16 on service provider devices 22/26 of additional service providers, such as garages or repair shops, where each bid comprises a cost and a service time. Application server 20 is operable to transmit the additional bids to the user application 18. Application server 20 is operable to receive the selected additional bid corresponding to an additional service provider. Application server 20 is operable to send notification to the selected additional service provider indicating that their bid was selected. The destination of the original service request may change depending on the location of the additional service provider. Application server 20 is operable to send notifications to the remaining service providers indicating that their bids were not selected and the details (time, cost) of the selected bid.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

1. A computer implemented method for bidding on service requests wherein the computer comprises a processor and a memory coupled to the processor and configured to store instructions executable by the processor to perform the method comprising:
receiving a service request from a user device, wherein the service request indicates a user identifier, an item to be service, a location and a destination;
generating a bid request corresponding to the service request;
receiving a plurality of bids from a corresponding plurality of service provider devices, wherein each bid indicates a service provider identifier for a corresponding service provider, a cost for servicing the item and a service time;
transmitting the plurality of bids to the user device; and
receiving a selected bid of the plurality of bids from the user device.

2. The method of claim 1, wherein the service request further indicates a requested service time.

3. The method of claim 1, wherein the service request is received from a user computing application executing on the user device, and wherein the location is automatically determined using a global positioning system of the user device.

4. The method of claim 1, wherein each of the plurality of bids is received by a bidder computing application executing on the service provider device of the corresponding service provider.

5. The method of claim 1, further comprising sending a notification to the service provider device corresponding to the selected bid, wherein the notification indicates that their bid was selected.

6. The method of claim 1, further comprising sending a notification to each of the remaining services provider devices, wherein the notification indicates that their bid was not selected, and the cost and the service time of the selected bid.

7. The method of claim 1, further comprising providing a price range for a reasonable bid for the location and the destination, wherein the price range is generated based on at least one of historical data for similar service requests and industry standards.

8. The method of claim 1, further comprising generating an additional bid based on the received plurality of bids, and transmitting the additional bid as part of the plurality of bids, wherein the selected bid may be the additional bid.

9. The method of claim 1, further comprising, for each of the plurality of service providers, authenticating the respective service provider using the service provider identifier.

10. The method of claim 1, further comprising receiving server provider authentication data from the user device, authenticating the respective service provider using the service provider authentication data, and transmitting a notification to the user device indicating a result of the authentication.

11. The method of claim 1, further comprising, for each of the plurality of service providers, receiving a defined geographic area for the respective service provider, and transmitting the bid request to the respective service provider only if the location and the destination of the service request is within the defined geographic area for the respective service provider.

12. The method of claim 1, further comprising:
receiving a second service request;
transmitting a second bid request corresponding to the second service request;
receiving a plurality of additional bids from a corresponding plurality of additional service providers, wherein each bid comprises a cost and a service time;
transmitting the plurality of additional bids; and
receiving a selected additional bid of the plurality of additional bids, wherein the selected additional bid corresponds to a selected additional service provider of the plurality of additional service providers.

13. The method of claim 12, further comprising sending a notification to the selected additional service provider.

14. The method of claim 1, wherein the service request relates to a service for a vehicle and wherein the bid request comprises a vehicle identifier and one or more known issues with the vehicle.

15. The method of claim 1, wherein the service request relates to a service for a vehicle, wherein the service request is generated by a computing application executing on a mobile device, and wherein the bid request comprises telematics data for the vehicle, wherein the telematics data is received from a telematics device in communication with the mobile device.

16. A system for bidding comprising a processor and a memory coupled to the processor and configured to store instructions executable by the processor to provide:
a service request module operable to receive a service request from a user device, wherein the service request indicates a user identifier, an item to be service, a location and a destination;
a bid request module operable to generate a bid request corresponding to the service request;
a bid module operable to receive a plurality of bids from a corresponding plurality of service provider devices, wherein each bid indicates a service provider identifier for a corresponding service provider, a cost for servicing the item, and a service time; and transmit the plurality of bids to the user device;
and receive a selected bid of the plurality of bids from the user device.

17. The system of claim 16, further comprising a notification module operable to send a notification to the service provider corresponding to the selected bid, wherein the notification indicates that their bid was selected, and a notification to each of the remaining services providers, wherein the notification indicates that their bid was not selected and the cost of the selected bid.

18. The system of claim 16, further comprising a comparison module operable to provide a price range for a reasonable bid for the location and destination, wherein the price range is based on at least one of historical data for similar service requests and industry standards.

19. The system of claim 16, wherein the bid module is further operable to generate an additional bid based on the received plurality of bids and transmit the additional bid as part of the plurality of bids, wherein the selected bid may be the additional bid.

20. The system of claim 16, further comprising an authentication module operable to, for each of the plurality of service providers, authenticate the respective service provider based on the service provider identifier, and authenticate the user based on the user identifier.

21. The system of claim 16, wherein the authentication modules is further configured to receive server provider authentication data from the user device, authenticate the respective service provider using the service provider authentication data, and transmit a notification to the user device indicating a result of the authentication.

22. The system of claim 16, wherein the bid request module is further operable to, for each of the plurality of service providers, receive a defined geographic area for the respective service provider, and transmit the bid request to the respective service provider only if the location and the destination of the service request is within the defined geographic area for the respective service provider.

23. The system of claim 16, wherein the service request module is operable to receive a second service request; wherein the bid request module is operable to transmit a second bid request corresponding to the second service request; and wherein the bid module is operable to receive a plurality of additional bids from a corresponding plurality of additional service providers, wherein each bid comprises a cost and a service time, transmit the plurality of additional bids, and receive a selected additional bid of the plurality of additional bids, wherein the selected additional bid corresponds to a selected additional service provider of the plurality of additional service providers.

24. The system of claim 16, wherein the service request relates to a tow for a vehicle and servicing for the vehicle and wherein the service request comprises a vehicle identifier and one or more known issues with the vehicle.

25. The system of claim 24, wherein the service request is received by a computing application executing on a mobile device, and wherein one or more known issues with the vehicle is identified by telematics data for the vehicle, wherein the telematics data is received from a telematics device in communication with the mobile device.

26. A computer-readable storage medium storing one or more sequences of instructions which, when executed by one or more processors, causes the one or more processors to perform a method of bidding comprising:
a) receiving a service request from a user device, wherein the service request indicates a user identifier, an item to be service, a location and a destination;
b) generating a bid request corresponding to the service request;
c) receiving a plurality of bids from a corresponding plurality of service provider devices, wherein each bid indicates a service provider identifier for a corresponding service provider, a cost for servicing the item and a service time;
d) transmitting the plurality of bids to the user device; and
e) receiving a selected bid of the plurality of bids from the user device.
